(19) United States
(12) Patent Application Publication
(10) Pub. No.: US 2009/0136771 A1
(43) Pub. Date: May 28, 2009

(54) COMPOSITION FOR PREPARING A SURFACE FOR COATING AND METHODS OF MAKING AND USING SAME

(76) Inventors: Ronald J. Evans, Ponte Vedra Beach, FL (US); Kevin Halstead, Tulsa, OK (US)

Correspondence Address: Hall, Estill, Hardwick, Gable, Golden &;Nelson, P.C., 100 North Broadway, Chase Tower, Suite 2900, Oklahoma City, OK, 73102, US

(21) Appl. No.: 12/324,034

(22) Filed: Nov. 26, 2008

Related U.S. Application Data
(60) Provisional application No. 60/990,709, filed on Nov. 28, 2007.

(51) Int. Cl. B32B 15/04; C09K 13/04; C23F 1/28

(52) U.S. Cl. 428/469; 252/79.2; 216/108; 428/457; 216/95

(57) ABSTRACT

Compositions for preparing a surface which, when applied to a variety of substrates provides improved adhesion performance for applying a coating. The compositions are aqueous mixtures containing an effective amount of an acid, iron, and zinc and methods of making and using same.

### CROSS REFERENCE TO RELATED APPLICATIONS

This application claims the benefit of U.S. Provisional Application Ser. No. 60/990,709, filed Nov. 28, 2007, which is hereby incorporated by reference.

### STATEMENT REGARDING FEDERALLY SPONSORED RESEARCH OR DEVELOPMENT

Not Applicable.

### BACKGROUND OF THE INVENTION

1. Field of the Invention

The present invention relates, in general, to a composition for preparing a surface of a substrate and methods of making and using same. More particularly, but not by way of limitation, the composition and method relates to preparing a galvanized steel surface resulting in improved adhesion performance when a coating is applied.

2. Description of Prior Art

Galvanizing provides a barrier between all internal and external steel surfaces and their environment. Hot dip galvanizing provides fabricated iron or steel products with maximum protection through a continuous, tough, metallurgically bonded coating. In both hot dip galvanizing and sheet galvanizing, the surface of the steel is completely covered with a uniform zinc alloy coating.

As with many other substrates, neither organic nor inorganic coatings can usually be applied directly onto galvanized steel. Thus, the surface of the galvanized steel must be prepared for a coating application, One recognized method of surface pre-treatment in the prior art that produces a sound substrate for applying a coating is abrasive blasting. Abrasive blasting of a surface to create a profile is the industry standard for steel surface preparation for paint and/or polymer coatings. Currently, after fabrication, steel products that have been galvanized are abrasive blasted to create a profile (typically 2.5 mil profile) to which a coating adheres. There are a number of negative factors associated with this process: high capital expense for equipment, material costs, spent media disposal, and environmental compliance to control air emissions. Additionally, abrasive blasting can fracture the galvanized coating resulting in a loss of the corrosion protection this provides. This quality issue has been linked to failures in the field and is difficult to detect once the product is coated.

While the method of the prior art provides a surface prepared for paint and/or polymer coatings/layers, such prior art method is generally lacking. Thus, a need has long existed for improved compositions for preparing a surface and which, when applied to a substrate, such as a steel substrate, provide improved adhesion performance. It is to such compositions and methods by which such compositions are manufactured and applied to substrates that the present invention is directed.

### BRIEF SUMMARY OF THE INVENTION

The present invention provides compositions and methods of using and making said compositions, having improved adhesion performance which, when applied to a variety of substrates, coated and uncoated, and when cured have improved adhesion properties.

Broadly, chemical etching compositions of the present invention include an aqueous mixture containing an effective amount of an acid, zinc and iron. The acid is present in the aqueous mixture at a concentration of between about 50 g/l and about 180 g/l, the zinc is present in the aqueous mixture at a concentration of between about 5 g/l and about 80 g/l and the iron is present in the aqueous mixture at a concentration of between about 50 g/l and about 160 g/l. In one embodiment, the acid is hydrochloric acid.

A method of the present invention prepares a surface of a coated or uncoated substrate to provide improved adhesion performance to the surface of the coated or uncoated substrate. A chemical etching composition is applied to at least one surface of the substrate. The chemical etching composition including an aqueous mixture containing an effective amount of an acid, zinc, and iron. In one embodiment, the substrate is steel which is galvanized or ungalvanized. The chemical etching composition is cured to provide the at least one surface of the coated or uncoated substrate with a cured coating having improved adhesion performance.

It is an object of the present invention to provide compositions and methods of making and using said compositions providing improved adhesion to a substrate. It is a further object of the present invention to provide articles having a substrate which have improved adhesion properties.

Other objects, advantages and features of the present invention will become apparent upon reading the following detailed description in conjunction with the appended claims.

### DETAILED DESCRIPTION OF THE PRESENT INVENTION

In accordance with the present invention, compositions and methods are provided for preparing surfaces of various substrates. For example, in one embodiment, the present chemical etch composition is utilized to prepare the surface of a substrate, such as steel, both galvanized and bare or black, for coating. For example, when applied to a galvanized coating, the chemical etch composition reacts with the galvanized coating, but only on the surface so that there is not a measurable reduction in the thickness of the galvanized coating. It should be understood by one of ordinary skill in the art that the composition of the present invention may be utilized on other substrates such as ferrous metals, nonferrous metals, metal alloys, and the like.

In one embodiment of the present invention, the composition and method of the present invention prepare the surface of galvanized steel that result in adhesion performance that exceeds the adhesion performance of abrasive blasting methods. In addition, the method is more economical than the present cost of abrasive blasting. The composition may be used to prepare the surface of a substrate so as to apply polyurethane coatings, as well as other types of coatings/paint. A variety of commercially available coating systems can be applied depending on the chosen purpose such as architectural, industrial, etc.

According to one embodiment of the present invention, broadly, the composition contains an acid, iron and zinc, all in aqueous solution. In one embodiment, the acid is hydrochloric acid. The hydrochloric acid is present in the aqueous composition in an amount of about 50 g/L to about 180 g/L. The iron is present in the aqueous solution in an amount of about 50 g/L- about 160 g/L. In one embodiment, the iron is present in the form of FeCl₂. It should be understood that any iron source may be utilized so long as the source functions in accordance with the present invention. The zinc is present in the aqueous composition in an amount of about 5 g/L to about 80 g/L. In one embodiment, zinc chloride (ZnCl₂) may be utilized. It should be understood that any zinc source may be utilized so long as the source functions in accordance with the present invention. In one embodiment of the composition of the present invention, both iron and zinc are dissolved in the acid, which inherently forms the iron chloride and zinc chloride due to the reaction with HCI, however, one of ordinary skill in the art will understand that the chemicals can also be mixed by any known method of mixing. In one embodiment, the balance of the aqueous composition is water and other dissolved metals, such as lead, cadmium, chromium, nickel, and barium all at concentrations less than about 1,000 ppm. The composition of the present invention can be produced as a byproduct from steel pickling or manufactured from its primary components.

The chemical etch composition may be applied to a product by various methods known in the art, such as, for example, immersion in a dip tank or by spraying. Significant performance differences between these methods have not been observed, though there are operational differences. In both methods, the area of a product requiring coating must be wetted with the chemical etch composition typically for about four minutes or less. Preferably, the area is wetted for about one minute or less to ensure reaction between the solution and substrate. The area must then be thoroughly rinsed with water (tap water has been used in all testing). The product is then dried (air dry or forced drying) prior to coating. In one embodiment, the dry time is completely dependent on atmospheric conditions. However, it should be understood by one of ordinary skill in the art that any known method of drying may be utilized so long as the method functions in accordance with the present invention as described herein. The chemical reaction of the composition on a galvanized surface may dull the galvanized surface, thus it may be necessary to control where the composition is applied for aesthetic reasons.

Immersion requires an open top dip tank large enough to handle the largest product that requires coating, thus, a large amount of the chemical etch composition may be needed to fill the required tank. Masking can be performed if only a portion of the product requires coating. Coverage is uniform and complete when immersing the product.

Spraying can be performed with a pump up sprayer or other appropriate device. Application can be controlled to wet only the portion that requires coating. It should be understood by one of ordinary skill in the art that a number of various spray or immersion techniques may be utilized in accordance with the present invention.

Additionally, it should be understood by one of ordinary skill in the art that the compositions of the present invention may be applied to various products, such as continuous coils, sheets, tubes, steel wires, poles or the like, where the improved adhesion performance properties of the present invention provides an advantage o the desired product.

In relation to the galvanized steel substrate, the chemical etch composition and method has several benefits over the current industry standard, abrasive blasting. The capital required for equipment is low, especially if the spray method is used. The material costs for the solution and the unit cost of disposal per product processed are lower. Typically, labor costs will be lower as well. Thus, the chemical etch composition is more economical. Though an air permit might be required for utilizing the chemical etch composition, this likely would only occur in a very high production facility. In almost all situations, abrasive blasting requires a permit and controls. Abrasive blasting requires operator skill for consistency, where as the chemical etching is a more forgiving process. Additionally, abrasive blasting can fracture the galvanized coating off the steel which has been documented to result in failures. Minimally, in one embodiment, a small pump-up sprayer, a water source for rinsing, and optionally paint application equipment are needed to perform the method of the present invention as disclosed herein. Finally, the chemical etching is a good solution for field repairs. The chemical etch only reacts on the surface of the coated substrate and does not measurably reduce the thickness of the galvanized coating.

The effectiveness of steel surface preparation for painting is measured by the coating's adhesion to the substrate. There are two common adhesion tests within the industry segment that are typically used to evaluate adhesion: pull-off strength (pull adhesion) (measured in psi) by ASTM D4541 and cathodic disbondment (measured in mm disbanded) by ASTM G95. The pull adhesion is measured by gluing a dolly to a flat coated surface and measuring the force (pounds per square inch, psi) required to pull the dolly off. Cathodic disbondment attempts to measure the amount of undercutting that may occur. So, the coating is scored (i.e. scratched down to the substrate), an electrolyte solution (salt solution) is put in contact with the scored area and a current is applied to the substrate. The coating is then scraped away to where it is still adhered using a tool and the measurement is the radius in millimeters (mm). Thus, a lower value for cathodic disbondment indicates better adhesion.

In order to further illustrate the present invention, the following examples are given. However, it is to be understood that the examples are for illustrative purposes only and are not to be construed as limiting the scope of the subject invention.

### EXAMPLES

Table 1 shows the results of tests conducted using chemical etch compositions and method of the present invention as previously discussed. An aromatic polyurethane two part coating system, which is typically used in the industry for coating imbedded pole structures, was one of the coatings utilized. Aromatic polyurethane coatings were sensitive to moisture on the substrate. Thus, after rinsing, the coatings were dried to remove any moisture. If drying was very poor then overall adhesion was difficult. Visually undetectable amounts of moisture on a substrate results in pinholes or small bubbles with polyurethane coatings. Care was taken to ensure the substrate temperature was well above the dew point and to not apply such coatings in very high humidity conditions. Water cure urethanes or other coating types may be used as replacements. A variety of commercially available coating systems can be applied depending on the chosen purpose such as architectural, industrial, etc. Data was collected on samples prepared using abrasive blasting and from stated performance on coating technical data sheets that call for abrasive blasting preparation.

TABLE 1

| | | | | Knife | | |
|---|---|---|---|---|---|---|
| | | | | Adhesion | | Cathodic |
| Sample | Surface | | | 0-10 | Pull Adhesion | Disbondment |
| Type | Preparation | Wet Time | Coating | subjective | psi | mm radius |
| Example 1 | | | | | | |
| Galv | STL N. Pickle + rinse + | 1 min | | | 3171 | 0 |
| | 1303 + rinse, S1 | | | | | |
| Galv | STL N. Pickle + rinse + | 1 min | | | 3253 | 0 |
| | 1303 + rinse, S5 | | | | | |
| Galv | STL N. Pickle + | 1 min | | | 3606 | 0 |
| | rinse, S6 | | | | | |
| Galv | STL N. Pickle + | 1 min | | | 3742 | 1 |
| | rinse, S7 | | | | | |
| Example 2 | | | | | | |
| Galv | TP2 - pickle + rinse | 3 min | | | 3878 | 10.4 |
| Galv | TP2- pickle + rinse | 1 min | | | 4013 | 11.9 |
| Comparative | | | | | | |
| Example 1A | | | | | | |
| Galv | abrasive blast, NAGC | NA | CC | | 2764 | 14.3 |
| Galv | abrasive blast, T&B | NA | PC | | 1650 | 35 |
| Galv | Pickle + rinse | 1.5 min | CC | | 3905 | 9.1 |
| Galv | Pickle + rinse | 1.5 min | PC | | 4937 | 4.2 |
| Comparative | | | | | | |
| Example 2A | | | | | | |
| Galv | Bonderite 1303 + | | CC | 4 | 1733 | |
| | rinse | | | | | |
| Galv | Bonderite 1303 + | | CC | | | 33 |
| | rinse | | | | | |
| Galv | Bonderite 1303 + | | CC | 3 | 1933 | |
| | rinse | | | | | |
| Galv | Bonderite 1303 + | | CC | | | 19 |
| | rinse | | | | | |
| Galv | Bonderite 3410 + | | CC | 7 | 2600 | |
| | rinse + 1303 + rinse | | | | | |
| Galv | Bonderite 3410 + | | CC | | | 33 |
| | rinse + 1303 + rinse | | | | | |
| Galv | Pickle etch + rinse + | | | | 3362 | 4.4 |
| | Bonderite 1303 + | | | | | |
| | rinse | | | | | |
| Galv | Bonderite 1303 + | | | | | 23.5 |
| | rinse | | | | | |
| Galv | Bonderite 1303 + | | | | 3307 | |
| | rinse | | | | | |
| Galv | Bonderite 1303 + | | | | | 32.3 |
| | rinse | | | | | |
| Galv | Bonderite 1303 + | | | | 2981 | |
| | rinse | | | | | |

### Example 1

Twenty four (24) galvanized steel panels were prepared by two different methods, as shown in Table 1. The first method (Method 1) was to chemically etch the panel for 1 minute, then rinse, then apply a commercially available surface preparation chemical (Bonderite 1303) from Henkel Specialty Chemicals, then rinse and allow to dry before coating with polyurethane. The second method (Method 2) was to chemically etch the panel for 1 minute, then rinse and allow to dry before coating with polyurethane. The method utilized tap water for the rinse and a chemical etch solution containing approximately 150 g/L HCL, 48 g/L Fe, and 50 g/L Zn. After coating, several sample panels experienced bubbling and pinholing due to incomplete drying. However, eight panels did not have this problem and were tested for adhesion. Two panels prepared with Method 1 had pull-off adhesion results of 3171 and 3253 psi. Two panels prepared with Method 1 did not experience cathodic disbondment at all, i.e. 0.0 mm radius. Two panels prepared with Method 2 had pull-off adhesion results of 3606 and 3742 psi. Two panels prepared with Method 2 had cathodic disbondment results of 0.0 and 1.0 mm radius.

### Example 2

Four hot dip galvanized steel coupons were prepared for coating with a solution containing 122 g/L HCI, 92 g/L Fe, and 18 g/L Zn (Table 1). Two coupons (MCC2 and MCC3) were prepared by wetting with the solution for 1 minute and two coupons (MCC16 and MCC17) were prepared by wetting with the solution for 3 minutes. All coupons were rinsed with tap water and allowed to dry prior to coating with and aromatic polyurethane coating. The adhesion pull-off strength was 4013 psi and 3878 psi for coupons MCC3 and MCC16 respectively. Cathodic disbondment testing results were 11.9 mm radius and 10.4 mm radius for coupons MCC 2 and MCC17, respectively.

### Comparative Example 1A

Multiple galvanized steel panels were prepared both by chemical etch and abrasive blasting then coated with two different polyurethane coatings (Corrocote and PoleClad) (Table 1). The chemical etch solution used varied in concentration due to its use on a large number of samples (109-125 g/L HCL, 92-97 g/L Fe, and 48-53 g/L Zn). Chemically etched panels had pull adhesion results ranging from 3008-5290 psi (average of 4421 psi) and cathodic disbondment results ranging from 4.2-29.9 mm radius (average of 10.95 mm radius). In regards to the cathodic disbondment results one coupon out of 6 tested had a cathodic disbondment of 29.9 mm radius, the next highest measurement was 10.1 mm radius. Thus, it is likely this one result was due to contamination of the substrate rather than the chemical etch itself (average cathodic disbondment results without the highest reading were 7.16 mm radius). Abrasive blasted panels had pull adhesion results ranging from 1134-3334 psi (average of 2207 psi) and cathodic disbondment results ranging from 13.1-35.0 mm radius (average of 26.1 mm radius). Additionally, 3 of the 6 abrasive blasted panels disbanded to the edge of the panel which was 35 mm radius.

### Comparative Example 2A

As shown in Table 1, twelve galvanized steel panels were prepared by various methods before coating with polyurethane. Method 1: applied Bonderite 1303 (commercially available from Henkel Specialty Chemicals), water rinse, and allow to dry. Method 2: applied Bonderite 3410 (commercially available from Henkel Specialty Chemicals), then water rinse, applied Bonderite 1303, water rinse, and allow to dry. Method 3: applied chemical etch (concentrations within typical ranges), water rinse, applied Bonderite 1303, water rinse, and allowed to dry. The steel panels were tested for pull-off adhesion and cathodic disbondment with the following results: Method 1—pull-off results range of 1733-3307 psi (average of 2489 psi), cathodic disbondment results range of 19-33 mm radius (average of 27.0 mm radius); Method 2—pull off result of 2600 psi, cathodic disbondment result of 33 mm radius; Method 3—pull off result of 3362 psi, cathodic disbondment result of 4.4 mm radius. These results along with those in Example 1 demonstrate that the chemical etch composition of the present invention provides the surface preparation that results in the best adhesion compared to the known commercially available surface preparation solutions.

From the present description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A composition for providing improved adhesion of a coating subsequently applied thereto, comprising:
an aqueous mixture containing an effective amount of an acid, zinc and iron; and
an amount of water sufficient to provide a resultant mixture.

2. The composition of claim 1 wherein the acid is hydrochloric acid.

3. The composition of claim 1 wherein the acid is present in the aqueous mixture at a concentration of between about 50 g/l and about 180 g/l.

4. The composition of claim 1 wherein the zinc is present in the aqueous mixture at a concentration of between about 5 g/l and about 80 g/l.

5. The composition of claim 1 wherein the zinc is zinc chloride.

6. The composition of claim 1 wherein the iron is present in the aqueous mixture at a concentration of between about 50 g/l and about 160 g/l.

7. The composition of claim 1 wherein the iron is iron chloride.

8. The composition of claim 1 further comprising an amount of dissolved metals present at concentration of less than about 1000 ppm.

9. The composition of claim 1 wherein the composition is produced as a byproduct from steel pickling.

10. A method for preparing a surface of a substrate to provide improved adhesion performance, comprising the step of:
applying to at least one surface of a substrate a chemical etching composition comprising an aqueous mixture containing an effective amount of an acid, zinc, and iron.

11. The method of claim 10 wherein the substrate is steel.

12. The method of claim 11 wherein the steel is galvanized.

13. The method of claim 10 wherein the acid is hydrochloric acid.

14. The method of claim 10 wherein the acid is present in the aqueous mixture at a concentration of between about 50 g/l and about 180 g/l.

15. The method of claim 10 wherein the zinc is zinc chloride.

16. The method of claim 10 wherein the zinc is present in the aqueous mixture at a concentration of between about 5 g/l and about 80 g/l.

17. The method of claim 10 wherein the iron is iron chloride.

18. The method of claim 10 wherein the iron is present in the aqueous mixture at a concentration of between about 50 g/l and about 160 g/l.

19. The method of claim 10 further comprising an amount of water sufficient to provide a resultant mixture.

20. The method of claim 10 wherein the chemical etching composition is applied by spraying onto the substrate with a dwell time of less than about one minute.

21. The method of claim 10 further comprising the step of:
curing the chemical etching composition to provide the substrate with a cured coating having improved adhesion performance.

22. An article comprising:
a substrate; and
a coating formed on at least one surface of the substrate, the coating providing improved adhesion performance to a surface of the substrate and the coating being formed by curing a chemical etching composition comprising an aqueous mixture containing an add, iron, and zinc.

23. The method of claim 22 wherein the substrate is steel.

24. The method of claim 23 wherein the steel is galvanized.

25. The method of claim 22 wherein the acid is hydrochloric acid.

26. The method of claim 22 wherein the acid is present in the aqueous mixture at a concentration of between about 50 g/l and about 180 g/l.

27. The method of claim 22 wherein the zinc is zinc chloride.

28. The method of claim 22 wherein the zinc is present in the aqueous mixture at a concentration of between about 5 g/l and about 80 g/l.

29. The method of claim 22 wherein the iron is iron chloride.

30. The method of claim 22 wherein the iron is present in the aqueous mixture at a concentration of between about 50 g/l and about 160 g/l.

31. The method of claim 22 further comprising an amount of water sufficient to provide a resultant mixture.

32. The method of claim 22 wherein the chemical etching composition is applied by spraying onto the substrate with a dwell time of less than about four minutes.
